(19) United States
(12) Patent Application Publication
(10) Pub. No.: US 2003/0007202 A1
(43) Pub. Date: Jan. 9, 2003

(54) Microelectromechanical system (MEMS) based tunable hitless add-drop filter

(75) Inventors: Christophe Moser, Pasadena, CA (US); Demetri Psaltis, Pasadena, CA (US); Gregory Steckman, Pasadena, CA (US); Wenhai Liu, Pasadena, CA (US)

Correspondence Address: Jonathan L. Pettit, Brobeck Phleger & Harrison LLP, 12390 El Camino Real, San Diego, CA, 92130-2081, US

(73) Assignee: ONDAX, INC.

(21) Appl. No.: 10/143,263

(22) Filed: May 9, 2002

Related U.S. Application Data
(60) Provisional application No. 60/289,946, filed on May 9, 2001.

(51) Int. Cl. G02B 5/32; G02B 5/18

(52) U.S. Cl. 359/15; 359/572

(57) ABSTRACT

A tunable optical filter includes a movable reflector, such as a three-dimensional microelectromechanical system (MEMS) actuated mirror and a plurality of holographic gratings each having a predetermined Bragg wavelength to select the wavelength to be filtered or dropped from broadband or wavelength-multiplexed input optical signals.

### RELATED APPLICATION

Under 35 U.S.C. §120 the present application claims the benefit of U.S. Provisional Patent Application entitled “MICROELECTROMECHANICAL SYSTEM (MEMS) BASED TUNABLE HITLESS DROP FILTER,” having Serial No. 60/289,946, filed May 9, 2001, of which the provisional application is assigned to the assignee of the present application, and the disclosure of the provisional application is hereby incorporated by reference.

### BACKGROUND OF THE INVENTION

1. Field of the Invention

The present invention relates to optical filters, and more particularly, to tunable optical filters.

2. Background Art

Various types of optical filters have been developed for optical fiber networks in broadband telecommunications systems. Because of increasing demand for high speed broadband data communications, optical wavebands at infrared wavelengths in the range of about 1450 nm to about 1650 nm are increasingly being used as data carriers in telecommunications systems to satisfy the demand for high speed broadband data transmission. Fixed wavelength optical filters have been implemented in conventional optical fiber communications networks to filter narrowband or single-wavelength optical signals from broadband or wavelength-multiplexed optical signals, for example. Tunable optical filters are becoming increasingly important in all optical networks because they allow the networks to perform more flexible optical wavelength selection, switching and routing. In a dense wavelength division multiplexing (DWDM) optical networks, tunable filters can implement dynamic provisioning at the transport level, i.e. the filter dynamically selects wavelength channels which are assigned predetermined wavelengths according to a predetermined spectral grid, for example, an industry-standard spectral grid defined by the International Telecommunications Union (ITU).

Typical examples of existing tunable optical filters include Fabry-Perot interferometer tunable filters, liquid crystal Fabry-Perot filters, micro-machined filters, Mach-Zehnder interferometer filters, fiber Bragg grating (FBG) filters, acousto-optic tunable filters, electro-optical tunable filters, arrayed waveguide grating filters, and ring resonator tunable filters. These types of tunable optical filters are described in D. Sadot and E. Boimovich, “Tunable Optical Filters for Dense WDM Networks”, IEEE Communications Magazine pages 50-55, December 1998, incorporated herein by reference.

Many of these conventional tunable optical filters include physical elements that combine the functions of both filtering and tuning. For example, a conventional Fabry-Perot tunable optical filter has two highly reflective mirrors which define a resonant cavity. The resonant wavelength of such a conventional Fabry-Perot tunable optical filter can be tuned by moving one of the mirrors relative to the other to change the spacing between the mirrors, for example. The filtering element, that is, the highly reflective mirrors defining the resonant cavity in a conventional Fabry-Perot tunable optical filter, performs the functions of both filtering and tuning. It is desirable that in a tunable optical filter, different physical elements be implemented to perform the separate functions of filtering and tuning to achieve a high degree of stability and reliability.

Attempts have been made to realize tunable optical filtering systems that utilize separate physical elements to perform the functions of filtering and tuning. For example, a tunable optical filter has been proposed which includes a reflective diffraction grating to separate or demultiplex wavelength channels in a broadband optical signal and an array of microelectromechanical system (MEMS) switches to recombine the wavelength channels. An example of this type of tunable optical filter is described in “wavelength Add-drop switching using tilting mirrors”, J. Ford et. Al., Journal of Lightwave Technology, vol 17, No 5, 1999, incorporated herein by reference. However, this type of tunable optical filter with reflective diffraction grating is typically limited to broadband filtering.

Therefore, there is a need for a tunable optical filter that utilizes separate physical elements to perform the functions of filtering and tuning. Furthermore, there is a need for a tunable optical filter that is capable of performing narrowband filtering to select individual wavelength channels as well as broadband filtering in a dense wavelength division multiplexing (DWDM) optical fiber communications system.

### SUMMARY OF THE INVENTION

The present invention provides a tunable optical filter, generally including: an optical input capable of conveying an input optical signal that occupies a plurality of wavelength channels; a movable reflector capable of assuming a selected one of a plurality of predetermined positions to reflect the input optical signal onto a respective one of a plurality of reflected optical paths; a plurality of holographic gratings or other wavelength selective grating such as thin film gratings each having a predetermined Bragg wavelength and positioned on a respective one of the reflected optical paths to generate a first output optical signal in a selected one of the wavelength channels corresponding to the predetermined Bragg wavelength and a second output optical signal in remaining ones of the wavelength channels excluding the predetermined Bragg wavelength; a first optical output positioned to receive the first output optical signal; and a second optical output positioned to receive the second output optical signal.

The tunable optical filter according to embodiments of the present invention utilizes separate physical elements to perform the functions of filtering and tuning, thereby providing a high degree of stability and reliability in repeated tuning operations. Furthermore, the tunable optical filter according to embodiments of the present invention can be used for narrowband filtering to separate wavelength channels selectively in a dense wavelength division multiplexing (DWDM) optical fiber communication system, or for broadband filtering in such a system. Furthermore, optical signals in wavelength channels other than the selected wavelength channel can be coupled effectively and efficiently to an optical output, while achieving “hitless” tuning which avoids the disturbance of the output of the remaining wavelength channels not selected by the filter when wavelength tuning is performed.

### BRIEF DESCRIPTION OF THE DRAWINGS

The present invention will be described with particular embodiments thereof, and references will be made to the drawings in which:

FIG. 1 shows a diagram of an embodiment of a tunable optical filter with an optical input coinciding with an “express” output for “express” optical signals in wavelength channels other than the selected wavelength channel, and a separate optical output for “dropped” output optical signals in the wavelength channel selected for filtering;

FIG. 1A shows a diagram of an embodiment of the coinciding optical input and express output in FIG. 1, with a circulator to isolate the express output optical signal from the input optical signal;

FIG. 2 shows a diagram of another embodiment of the tunable optical filter according to the present invention, with an optical input coinciding with an express output, a separate optical output for the dropped optical signal, and a curved mirror for reflecting and focusing light beams;

FIG. 3 shows a diagram of another embodiment of the tunable optical filter according to the present invention, with an optical input, two separate optical outputs and two focusing lenses for collimating the input and output light beams;

FIG. 4 shows a diagram of another embodiment of the tunable optical filter according to the present invention, with an optical input and two separate optical outputs, a curved mirror and two microelectromechanical system (MEMS) actuated reflectors; and

FIG. 5 shows another embodiment of the tunable optical filter according to the present invention, with an optical input, two separate optical outputs and a single collimating lens.

FIG. 6 shows another embodiment of the tunable optical filter according to the present invention, with an optical input, two separate optical outputs and a single collimating lens positioned at the Fourier plane of the movable 3-D mirror.

FIG. 7 shows yet another embodiment of the tunable optical filter according to the present invention, with an optical input, three separate optical output, two collimating lens forming a 4-f system and two movable 3-D mirrors.

### DETAILED DESCRIPTION

The embodiments of the tunable filter presented here describe different ways for accessing a bank of filters using movable mirrors such as micro electro-mechanical mirrors.

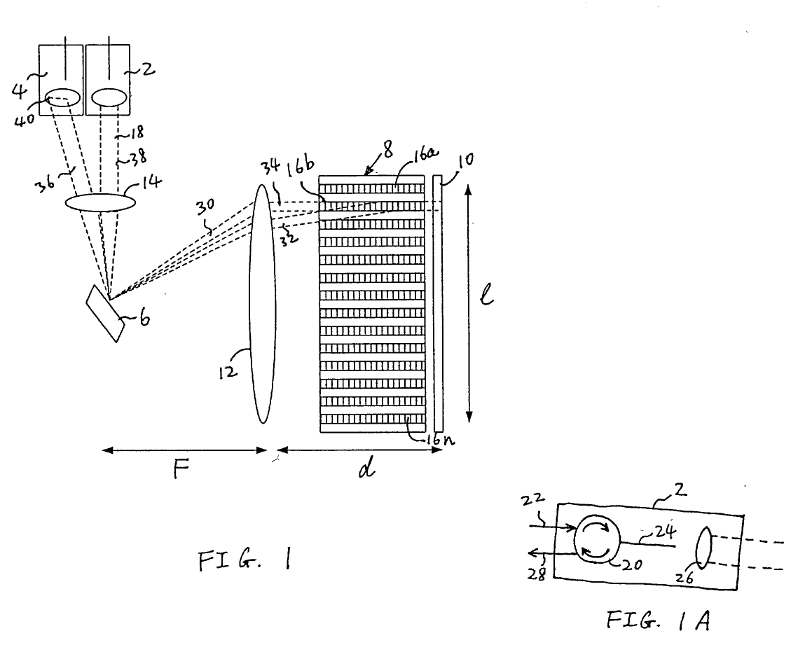

FIG. 1 shows a diagram illustrating an embodiment of a tunable optical filter with holographic gratings in accordance with the present invention. The tunable optical filter in the embodiment shown in FIG. 1 includes a first optical port 2, a second optical port 4, a movable reflector 6, a grating array 8, and a mirror 10 positioned adjacent the grating array 8. In addition, a first lens 12 is provided between the grating array 8 and the movable reflector 6 and a second lens 14 is provided between the movable reflector 6 and the first and second optical ports 2 and 4 to collimate input and output light beams along optical paths between the grating array 8, the movable reflector 6 and the first and second optical ports 2 and 4.

The term grating, as used in this patent, describes a perturbation of a material index of refraction in such a way that the resulting structure becomes wavelength selective. Examples of gratings comprise a holographic type (holographic gratings) or thin film type (thin film gratings). The grating array 8 comprises a plurality of gratings 16a, 16b, . . . 16n arranged substantially in parallel with each other. Each of the gratings 16a, 16b, . . . 16n has a distinct predetermined Bragg wavelength. When an incoming light beam hits a grating, the grating produces two separate light beams, one carrying optical signals at its predetermined Bragg wavelength and the other carrying optical signals at wavelengths other than its predetermined Bragg wavelength. In an embodiment in which the tunable optical filter as shown in FIG. 1 is implemented in a dense wavelength division multiplexing (DWDM) optical fiber communications network for selecting or dropping wavelength channels in the spectral grid defined by the International Telecommunications Union (ITU), each of the gratings 16a, 16b, . . . 16n in the array 8 includes a grating having a Bragg wavelength set to one of the predetermined wavelength channels in the ITU spectral grid. The holographic gratings or thin film gratings can be designed and manufactured in a conventional manner known to a person skilled in the art.

In the embodiment shown in FIG. 1, the first optical port 2 serves both as an optical input for transmitting an input light beam through the lens 14 to the movable reflector 6, and as an “express” optical output, that is, the output for receiving an output light beam which carries “express” output optical signals in remaining wavelength channels excluding the predetermined Bragg wavelength of the holographic grating selected for optical filtering. Both the input light beam and the express output light beam travel along the first optical path 18 between the first optical port 2 and the movable reflector 6 through the intermediary lens 14 in opposite directions. Therefore, the optical input and the express optical output coincide with each other at the first optical port 2.

FIG. 1A shows a diagram of an embodiment of the first optical port 2, in which an optical circulator 20 is implemented to separate the input optical signal from the express output optical signal, that is, the optical signal in wavelength channels other than the wavelength channel corresponding to the Bragg wavelength of the holographic grating selected for optical filtering. In FIG. 1A, the input optical signal which enters the first optical port 2 in a direction indicated by an arrow 22 is conveyed by the circulator 20 to an optical fiber 24, which transmits the input optical signal to a collimator 26 to produce a substantially parallel input light beam. The express output signal is transmitted from the collimator 26 to the optical fiber 24 in the reverse direction, and is subsequently conveyed through the circulator 20 to exit the first optical port 2 in a direction indicated by an arrow 28. Referring to FIG. 1, the input light beam carrying the input optical signal and the output light beam carrying the express output optical signal coincide along the first optical path 18, although the input optical signal and the express output optical signal travel in opposite directions.

In FIG. 1, the movable reflector 6 is positioned on the first optical path 18 to receive the input light through the lens 14 and reflects the input light beam onto a second optical path 30 to reach one of the optical gratings 16a, 16b, . . . 16n in the grating array 8. The input light beam transmitted by the first optical port 2 may carry a broadband or wavelength-multiplexed input optical signal that occupies a plurality of wavelength channels in the ITU spectral grid. In an embodiment, the movable reflector 6 comprises a microelectromechanical system (MEMS) actuated mirror, such as a three-dimensional MEMS actuated mirror capable of redirecting the light beam to different spatial locations in three dimensions. Other types of movable reflectors can also be implemented in the tunable optical filter within the scope of the present invention.

The movable reflector 6 is capable of assuming any one of a plurality of predetermined positions selected to reflect the input light beam onto a respective second optical path, for example, optical path 30 as shown in FIG. 1, to reach any one of the holographic gratings 16a, 16b, . . . 16n in the grating array 8 selected for optical filtering. The lens 12, which is positioned between the movable reflector 6 and the grating array 8, collimates the reflected input light beam along the second optical path 30 to produce a substantially parallel light beam before the reflected input light beam reaches the selected holographic grating.

In the example shown in FIG. 1, the input light beam is received by the second holographic grating 16b, which in response generates a first output light beam carrying a first output optical signal in a selected wavelength channel, also called a “dropped” channel, having a wavelength equal to the predetermined Bragg wavelength of the holographic grating 16b, and a second output light beam carrying a second output optical signal, that is, the “express” output optical signal in the remaining wavelength channels occupied by the input optical signal except the “dropped” wavelength channel which corresponds to the predetermined Bragg wavelength of the holographic grating 16b. The mirror 10, which is positioned adjacent to the grating array 8, reflects the “express” light beam onto optical path 34, through the lens 12 between the grating array 8 and the movable reflector 6. The light beam reflected from the grating is directed onto optical path 32. In the embodiment shown in FIG. 1, the mirror 10 comprises a planar mirror having a reflective surface substantially perpendicular to the holographic gratings 16a, 16b, 16n in the grating array 8. Various types of conventional gratings such as thin-film or holographic gratings may be used in the grating array 8. The terms “express” and “drop” used in this patent for holographic gratings should be exchanged when using thin film gratings.

The output light beams along optical paths 32 and 34 are focused by the lens 12 before they reach the movable reflector 6, which reflects these output light beams onto optical paths 36 and 38, respectively. In the embodiment shown in FIG. 1, the optical path 38 along which the second output light beam carrying the express output optical signal travels coincides with the first optical path 18 along which the input light beam travels. The second output light beam carrying the express output optical signal, that is, the signal in the remaining wavelength channels other than the wavelength channel corresponding to the predetermined Bragg wavelength of the selected holographic grating, reaches the first optical port 2 which serves both as the optical input and as the express optical output.

The first output light beam carrying the first output optical signal, that is, the “dropped” optical signal in the selected wavelength channel corresponding to the predetermined Bragg wavelength of the selected holographic grating, travels along the fifth optical path 36 and reaches the second optical port 4, which is positioned to receive the first output light beam. In an embodiment, the second optical port 4 comprises a collimator 40 to collimate the first output light beam carrying the dropped optical signal for output along an optical fiber.

The focal lengths of the first and second lenses 12 and 14 and the spacings between the physical elements in the tunable optical filter as shown in FIG. 1 can be designed in a conventional manner apparent to a person skilled in the art. For example, the distance between the movable reflector 6 and the first lens 12 as well as the focal length F of the first lens 12 may be set to 60 mm and the distance d between the first lens 12 and the mirror 10 may be set to 20 mm, if the length 1 of the grating array 8 is 40 mm. The number of holographic gratings in the grating array 8 depends upon the number of wavelength channels that need to be selectively filtered from the input optical signal. In an embodiment, all of the optical paths from the movable reflector 6 to the grating array 8 and from the mirror 10 to the movable reflector 6 are collimated by the same lens 12 to avoid excessive dispersion of the light beams.

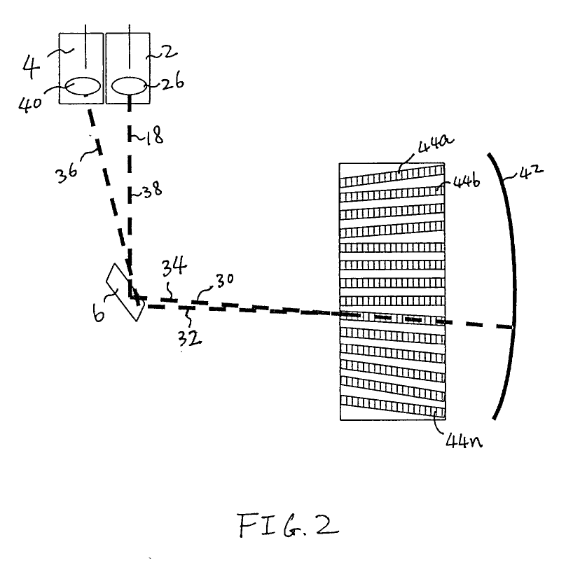

FIG. 2 shows a diagram of another embodiment of a tunable optical filter similar to that which is shown in FIG. 1 and described above, except that the planar mirror 10 in FIG. 1 is replaced by a curved mirror 42 in FIG. 2, and the substantially parallel holographic gratings 16a, 16b, . . . 16n in FIG. 1 are replaced by holographic gratings 44a, 44b, . . . 44n arranged in a substantially radial pattern as shown in FIG. 2. The curved mirror 42 in the embodiment shown in FIG. 2 obviates the need for the collimating lenses 12 and 14 in the embodiment shown in FIG. 1. Referring to FIG. 2, the first optical port 2 serves both as the optical input for transmitting the input light beam to the movable reflector 6 along the first optical path 18 and as the express optical output for receiving the second output light beam which carries the express output optical signal in the remaining wavelength channels except the dropped wavelength channel corresponding to the Bragg wavelength of one of the holographic gratings 44a, 44b . . . 44n selected for optical filtering.

In an embodiment, the first optical port 2 comprises a circulator for isolating the express output optical signal from the input optical signal and a collimator for collimating the input and output light beams in a configuration similar to that which is shown in FIG. 1A and described above. In FIG. 2, the second optical port 4, which is positioned to receive the first output light beam carrying the dropped optical signal, that is, the output optical signal in the selected wavelength channel corresponding to the Bragg wavelength of the selected holographic grating along the fifth optical path 36, comprises a second collimator 40 to collimate the first output light beam.

In FIG. 2, the holographic gratings 44a, 44b, 44n are arranged in a substantially radial pattern to receive the input light beam reflected by the movable reflector 6. In an embodiment in which the movable reflector 6 comprises a three-dimensional MEMS actuated mirror capable of assuming a selected one of a plurality of predetermined angular positions by rotating the angle of the mirror with respect to the first optical path 18, the second optical path 30 on which the reflected input light beam travels is capable of sweeping across the holographic gratings in a sector of an arc. Therefore, the holographic gratings 44a, 44b, . . . 44n are arranged in a substantially radial pattern to allow each of the holographic gratings to receive the input light beam reflected by the movable reflector 6.

Each of the holographic gratings 44a, 44b, . . . 44n has a predetermined Bragg wavelength and generates a first output light beam carrying the dropped output optical signal in the selected wavelength channel corresponding to the predetermined Bragg wavelength and a second output light beam carrying the express output optical signal in the remaining wavelength channels other than the selected wavelength channel corresponding to the Bragg wavelength upon receiving the reflected input light beam. In the embodiment shown in FIG. 2, the curved mirror 42 has a concave surface to reflect the “express” light beams onto optical path which is intercepted by the movable reflector 6.

In the embodiment shown in FIG. 2, the holographic gratings of the array reflect the light wavelength that matches the Bragg period of the holographic grating onto optical path 32, which is intercepted by the movable reflector 6.

In the embodiment shown in FIG. 2, the optical path 34 on which the second output light beam carrying the express output optical signal travels coincides with the second optical path 30 on which the reflected input light beam travels. The optical path 32 on which the first output light beam carrying the dropped output optical signal travels is separate from the optical path 34. In the embodiment shown in FIG. 2, no lens is placed between the movable reflector 6 and the holographic gratings 44a, 44b, . . . 44n or between the optical ports 2 and 4 and the movable reflector 6. The concave surface of the mirror 42 performs the function of compensating the natural diffraction of the collimated light beams.

The first and second output light beams produced by the holographic gratings and reflected by the curved mirror 42 are subsequently reflected by the movable reflector 6 onto optical paths 36 and 38, respectively. Because the optical path 38 on which the second output light beam carrying the express output optical signal travels coincides with the first optical path 18 on which the input light beam travels, the first optical port performs the functions of both transmitting the input optical signal and receiving the express output optical signal. The first output light beam carrying the dropped output optical signal in the wavelength channel corresponding to the Bragg wavelength of the selected holographic grating is collimated by the collimator 40 for output from the second optical port 4.

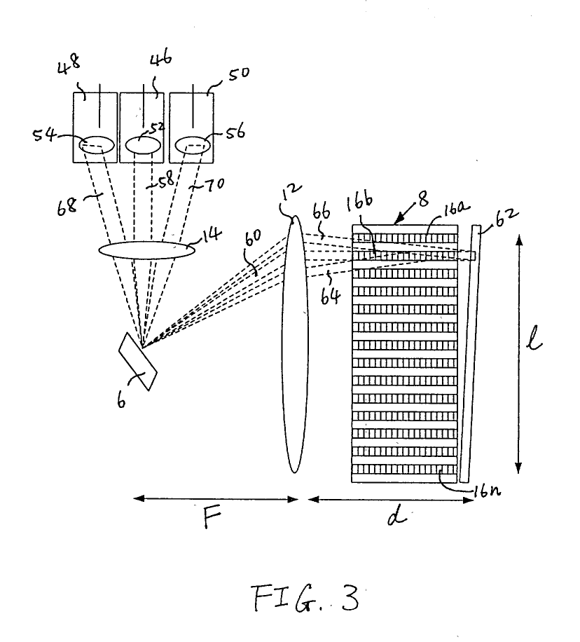

FIG. 3 shows a diagram of another embodiment of the tunable optical filter according to the present invention, with three separate optical ports for carrying the input light beam and the output light beams to obviate the need for a circulator in any of the optical ports to isolate the input and output optical signals. In FIG. 3, an input optical port 46 is implemented to transmit the input light beam to the movable reflector 6, while first and second output optical ports 48 and 50 are implemented to receive the first output light beam which carries the dropped output optical signal in the selected wavelength channel and the second output light beam which carries the express output optical signal in the remaining wavelength channels other than the selected wavelength channel, respectively. In an embodiment, the input optical port 46 and the first and second output optical ports 48 and 50 comprise first, second and third collimators 52, 54 and 56, respectively.

As shown in FIG. 3, the input light beam transmitted by the input optical port 46 travels along a first optical path 58 and is focused by the lens 14 before it is intercepted by the movable reflector 6. The movable reflector 6 reflects the input light beam onto a second optical path 60 to the lens 12, which collimates the reflected input light beam and passes the collimated light beam to one of the holographic gratings 16a, 16b, . . . 16n in the grating array 8 for optical filtering. In an embodiment, the movable reflector 6 comprises a three-dimensional MEMS actuated mirror which is capable of rotating to any one of a plurality of predetermined positions to reflect the input light beam onto one of a plurality of predetermined second optical paths to a respective one of the holographic gratings 16a, 16b, . . . 16n selected for optical filtering. Upon receiving the input light beam, the selected holographic grating produces a first output light beam which carries a dropped output optical signal in the selected wavelength channel corresponding to the Bragg wavelength of the selected holographic grating, and a second output light beam carrying an express output optical signal in the remaining wavelength channels other than the selected wavelength channel.

The “express” light beam propagating through the holographic grating chip is intercepted by a planar mirror 62 positioned at an angle with respect to the adjacent grating array 8.

The light beam with wavelength corresponding to the Bragg reflection wavelength of the holographic grating 16b is reflected by the holographic grating 16b and propagates along optical path 66.

In the embodiment shown in FIG. 3, the planar mirror 62 is positioned at a tilted angle with respect to the holographic gratings 16a, 16b, . . . 16n to reflect the “express” light beam onto optical path 64. In this embodiment, neither the “drop” light beam nor the “express” light beam coincides with the input light beam on any of the optical paths.

The first and second output light beams on the third and fourth optical paths 64 and 66 are focused by the lens 12 between the mirror 62 and the movable reflector 6 and then reflected by the movable reflector 6 onto fifth and sixth optical paths 68 and 70, respectively. The first and second output light beams which are reflected by the movable reflector 6 along the fifth and sixth optical paths 68 and 70 are collimated by the lens 14 before they reach the first and second optical ports 48 and 50, respectively. In the embodiment shown in FIG. 3, the input optical signal, the express output optical signal and the dropped output optical signal are transmitted and received by separate ports, thereby ensuring isolation between these signals. The dimensions and spacings of the physical elements in the embodiment of the tunable optical filter as shown in FIG. 3 may be similar to the embodiment which is shown in FIG. 1 and described above, for example, with F=60 mm, d=20 mm, and 1=40 mm.

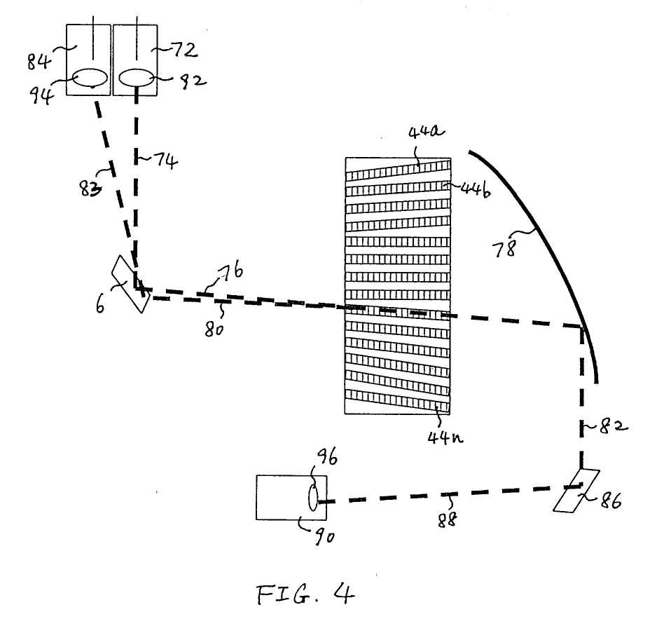

FIG. 4 shows a diagram of another embodiment of a tunable optical filter according to the present invention, with three separate optical ports and a curved mirror to obviate the need for collimating lenses between the optical ports and the movable reflector or between the movable reflector and the holographic gratings. In this embodiment, an input optical port 72 is positioned to transmit an input light beam carrying a broadband or wavelength-multiplexed input optical signal on a first optical path 74 to the movable reflector 6. The movable reflector 6, which in an embodiment comprises a three-dimensional MEMS actuated mirror, reflects the input light beam onto a second optical path 76, which leads to one of the holographic gratings 44a, 44b, . . . 44n selected for optical filtering.

The holographic gratings 44a, 44b, . . . 44n in the embodiment shown in FIG. 4 are arranged in a substantially radial pattern similar to that which is shown in FIG. 2 and described above. In an embodiment in which the movable reflector 6 comprises a three-dimensional MEMS actuated mirror that is rotatable to any one of a plurality of predetermined angular positions with respect to the first optical path 74 to reflect the input light beam onto a second optical path by sweeping the reflected input light beam in a sector of an arc, the holographic gratings 44a, 44b, . . . 44n which are arranged in a substantially radial pattern are each positioned to receive the reflected input light beam corresponding to the respective angular position of the movable reflector. Upon receiving the input light beam, the selected holographic grating generates a first output light beam carrying a dropped output optical signal in the selected wavelength channel corresponding to the Bragg wavelength of the holographic grating selected for optical filtering, and a second output light beam carrying an express output optical signal in the remaining wavelength channels occupied by the input optical signal except the selected wavelength channel in which the dropped output optical signal is carried.

The “express” output light beam is intercepted by the concave surface of a curved mirror 78, which reflects the light beam onto optical path 82. In the embodiment shown in FIG. 4, the first output light beam on the optical path 80 is reflected by the holographic grating onto the optical path 76, which is intercepted and reflected by the movable reflector 6 onto a fifth optical path 83 to a first output optical port 84, which is positioned to receive the first output light beam carrying the dropped output optical signal in the selected wavelength channel corresponding to the Bragg wavelength of the holographic grating selected for filtering.

In the embodiment shown in FIG. 4, an additional movable reflector 86 is provided to reflect the second output light beam received from the curved mirror 78 along the fourth optical path 82 onto the sixth optical path 88, which leads to a second output optical port 90. The second output light beam, which carries the express output optical signal in the wavelength channels occupied by the input optical signal except the selected wavelength channel corresponding to the Bragg wavelength of the selected holographic grating, is received by the second output optical port 90, which is separate from the input optical port 72.

In an embodiment, the movable reflectors 6 and 86 each comprise a three-dimensional MEMS actuated mirror to reflect the light beams onto desired optical paths. In an embodiment, the input optical port 72, the first output optical port 84 and the second output optical port 90 comprise first, second and third collimators 92, 94 and 96, respectively, to collimate the light beams entering and exiting the optical ports. Because the curved mirror 78 performs the function of compensating for the light beam natural diffraction, no lenses need be placed along the optical paths to collimate the light beams in free space other than the collimators in the input and output optical ports.

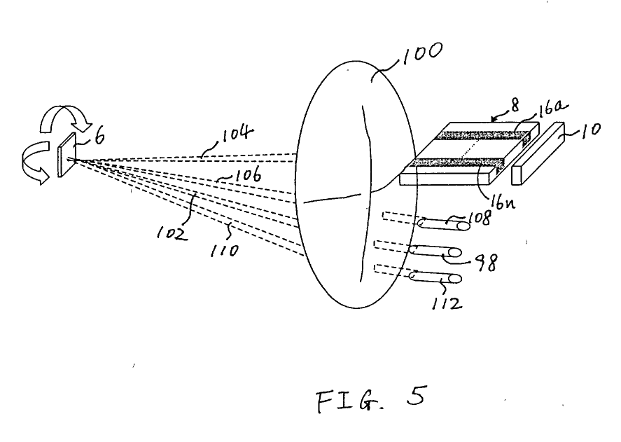

FIG. 5 shows a diagram of another embodiment of the tunable optical filter according to the present invention, with a single lens and three separate optical ports for transmitting the input light beam and receiving the first and second output light beams. In this embodiment, an input optical port 98 is positioned to transmit an input light beam carrying a broadband or wavelength-multiplexed input optical signal that occupies a plurality of wavelength channels on the first optical path 102 through a collimating lens 100. The input light beam focused by the lens 100 reaches the movable reflector 6, which reflects the input light beam onto a second optical path 104 to a grating array 8. The reflected input light beam on the second optical path 104 also passes through the collimating lens 100 before it reaches the grating array 8.

The movable reflector 6, which comprises a three-dimensional MEMS actuated mirror in an embodiment, is capable of assuming a selected angular position with respect to the first optical path to reflect the input light beam onto a respective second optical path to reach one of the holographic gratings 16a . . . 16n in the grating array 8 selected for optical filtering. In an embodiment, the holographic gratings 16a . . . 16n are arranged in a substantially parallel array in a manner similar to that which is shown in FIGS. 1 and 3 and described above.

Upon receiving the input light beam, the selected holographic grating generates a first output light beam which carries a dropped output optical signal in the selected wavelength channel corresponding to the Bragg wavelength of the selected holographic grating, and a second output light beam which carries an express output optical signal in the remaining wavelength channels occupied by the input optical signal except the selected wavelength channel in which the dropped output optical signal is carried. In a manner similar to that which is shown in FIG. 1 and described above, a planar mirror 10 is placed adjacent the grating array 8 to reflect the second output light beam (the “express beam”) back to the movable reflector 6 through the collimating lens 100. In an embodiment, the planar mirror 10 has a reflective surface positioned at a slight angle, similar to the mirror 62 of FIG. 3, with respect to the holographic gratings 16a, . . . 16n in the grating array 8.

The first output light beam which carries the dropped output optical signal is reflected by the holographic grating array 8, propagates back through lens 100, and is reflected by the movable reflector 6 onto an optical path 106 through the collimating lens 100 to a first output optical port 108, while the second output light beam which carries the express output optical signal is reflected by the movable reflector 6 onto another optical path 110 through the collimating lens 100 to a second output optical port 112. The first and second output optical ports 108 and 112 are positioned to receive the dropped and express output optical signals, respectively. Because the input optical port 98, the first output optical port 108 and the second output optical port 112 transmit and receive the input and output light beams separately, no circulator is needed in any of the optical ports to isolate the optical signals. In an embodiment, a collimator is provided in each of the input and output optical ports to collimate the light beams. In the embodiment shown in FIG. 5, only a single large collimating lens 100 is provided to focus all of the input and output light beams in free space because all of the optical paths pass through the collimating lens 100.

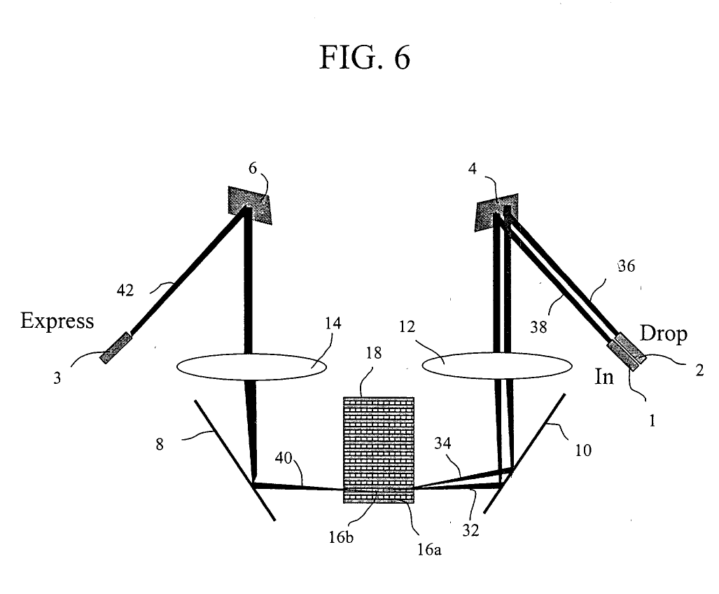

FIG. 6 shows a diagram of another embodiment of the tunable optical filter according to the present invention, with three separate optical ports for transmitting the input light beam and receiving the first and second output light beams. In FIG. 6, the input optical signal is collimated by collimator 1 to produce a substantially parallel input light beam. The light beam propagates onto optical path 38 and is reflected by the movable reflector 4.

In an embodiment, the center of the holographic grating array 18 is positioned at a distance from lens 12 equal to the focal length of lens 12 as shown in FIG. 6. The input light beam propagating on optical path 38 is focused by lens 12 and reflected by a fixed reflector 10 to reach one of the optical gratings 16a, 16b, . . . 16n in the holographic array 18. The input light beam may carry a broadband or wavelength-multiplexed input optical signal that occupies a plurality of wavelength channels in the ITU spectral grid. In an embodiment, the movable reflector 4 comprises a microelectromechanical system (MEMS) actuated mirror, such as a three-dimensional MEMS actuated mirror capable of redirecting the light beam to different spatial locations in three dimensions. Other types of movable reflectors can also be implemented in the tunable optical filter within the scope of the present invention.

The movable reflector 4 is capable of assuming any one of a plurality of predetermined positions selected to reflect the input light beam onto. For example, optical path 32 as shown in FIG. 6, to reach any one of the holographic gratings 16a, 16b, . . . 16n in the holographic array 18 selected for optical filtering. In the example shown in FIG. 6, the input light beam is received by the second holographic grating 16b, which in response generates a first output light beam carrying a first output optical signal in a selected wavelength channel, also called a “dropped” channel, having a wavelength equal to the predetermined Bragg wavelength of the holographic grating 16b, and a second output light beam carrying a second output optical signal, that is, the “express” output optical signal in the remaining wavelength channels occupied by the input optical signal except the “dropped” wavelength channel which corresponds to the predetermined Bragg wavelength of the holographic grating 16b. The second output beam which is the “express” light beam propagates through the holographic array and is reflected by the fixed reflector 8. The focal length of lens 14 is equal to the focal length of lens 12. Lens 14 is positioned at a distance from lens 12 equal to twice the focal lens of either lens 12 or 14. The movable mirror 6 reflects the collimated “express” light beam onto optical path 42 and onto optical output port 3. Output port 3 is a single fiber collimator. The movable mirror 6 moves at the same time as mirror 4 in order to keep the coupling into the output port 3.

The first output light beam carrying the first output optical signal, that is, the “dropped” optical signal in the selected wavelength channel corresponding to the predetermined Bragg wavelength of the selected holographic grating, is reflected by the holographic grating 16b and propagates onto optical path 34. The fixed reflector 10 directs the beam onto lens 12 which re-collimates the beam. The movable reflector 4 reflects the first output beam onto optical path 36 which in turn is coupled to the output 2 corresponding to the “drop” port. Output port 2 is a single fiber collimator.

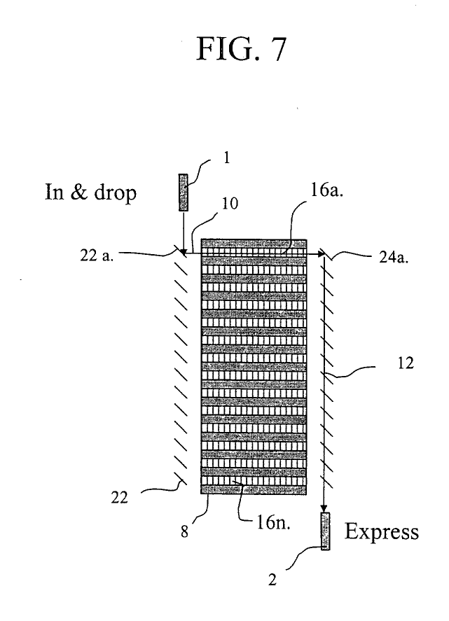

In the embodiment shown in FIG. 7, the first optical port 1 serves both as an optical input for transmitting an input light beam and as a “drop” optical output, that is, the output for receiving an output light beam which carries the signal corresponding to the predetermined Bragg wavelength of the holographic grating selected for optical filtering. Both the input light beam and the drop output light beam travel along the first optical path 10. The array of MEMs (microelectromechanical mirrors) 22 has a binary mode of operation. Each of the mirrors from the mirror array can be positioned in a way to either reflect the light beam or to let the light beam propagation unaffected. When one of the mirrors, (e.g 22a) is positioned so as to reflect the light beam, the reflected beam 10 is directed to the corresponding holographic filter (e.g 16a).

The first output light is the reflected light which contains the wavelength corresponding to the Bragg grating wavelength of one of the holographic gratings 16a, . . . , 16n. The first output light propagates along the same optical path as the optical input, but in the opposite direction. The mirror 22a reflects the first output light into the same input port as the input light. Not shown is a circulator that extracts the drop light beam.

The second output beam is the express light beam that propagates through the grating array 8. The MEMs mirror 24a is set in a position such as to reflect the express beam towards optical path 12. In this example, all other MEMs mirror from the MEMs array 24 are positioned to as to let the propagation of the light beam unaffected. The second output beam propagates along optical path 12 which is coupled to output port 2. Tunability is achieved by flipping the correct set of MEMs mirror to direct the beam onto the required holographic filter and to enable a clear optical path to the express port 2.

In the embodiments described above, the tuning elements, which are movable reflectors, are physically separate from the filtering elements, which are fixed holographic gratings. Because separate physical elements are implemented to perform the functions of filtering and tuning, a high degree of stability and reliability can be achieved in repeated and frequent tuning operations typically required to be performed in a modern DWDM optical fiber communications network. Furthermore, holographic gratings can be made in conventional manners known to a person skilled in the art to achieve very good filtering quality.

Tunable optical filters using holographic gratings according to embodiments of the present invention can be tuned to very narrow bandwidths, for example, on the order of about 25 GHz for the selection of wavelength channels in a DWDM system, as well as relatively wide bandwidths on the order of about 100 GHz, for example. The holograms may be made of any conventional type, such as conventional thin-film holograms that have spatially varying filtering characteristics which are well known to a person skilled in the art. Furthermore, “hitless” tuning is achieved by first tuning the light beam out of grating region, which is located at the top half of the holographic chip, to a lower region of the holographic array where the holographic grating is inexistent and second by tuning the light across the array in the region where no grating are present and third by tuning the optical beam back into the required holographic grating present at the top half of the grating array. The availability of express output optical signals in wavelength channels other than the dropped wavelength channel selected by the tunable optical filter affords a high degree of flexibility to designers and operators of DWDM optical wavelength switching and routing systems.

The present invention has been described with respect to particular embodiments thereof, and numerous modifications can be made which are within the scope of the invention as set forth in the claims.

What is claimed is:

1. An optical filter, comprising:
an optical input capable of conveying an input optical signal that occupies a plurality of wavelength channels;
a movable reflector capable of assuming a selected one of a plurality of predetermined positions to reflect the input optical signal onto a respective one of a plurality of reflected optical paths;
a plurality of holographic gratings each having a predetermined Bragg wavelength and positioned on a respective one of the reflected optical paths to generate a first output optical signal in a selected one of the wavelength channels corresponding to the predetermined Bragg wavelength and a second output optical signal in remaining ones of the wavelength channels excluding the predetermined Bragg wavelength;
a first optical output positioned to receive the first output optical signal; and
a second optical output positioned to receive the second output optical signal.

2. The filter of claim 1, wherein the optical input and the second optical output coincide with each other.

3. The filter of claim 2, wherein the first and second output optical signals are reflected by the movable reflector to the first and second optical outputs, respectively.

4. The filter of claim 3, further comprising a first lens positioned between the holographic gratings and the movable reflector to focus the input optical signal and to focus the first and second output optical signals.

5. The filter of claim 4, further comprising a second lens positioned between the movable reflector and the optical input and outputs to focus the input optical signal and to focus the first and second output optical signals.

6. The filter of claim 3, further comprising a mirror positioned adjacent the holographic gratings to reflect the second output optical signal to the movable reflector.

7. The filter of claim 6, wherein the holographic gratings are arranged in a substantially parallel array.

8. The filter of claim 7, wherein the mirror comprises a planar mirror having a surface substantially perpendicular to the holographic gratings.

9. The filter of claim 6, wherein the holographic gratings are arranged in a substantially radial pattern.

10. The filter of claim 9, wherein the mirror comprises a curved mirror having a concave surface to reflect the second output optical signal to the movable reflector.

11. The filter of claim 2, further comprising a circulator at the second optical output to isolate the second output optical signal from the input optical signal.

12. The filter of claim 1, wherein the optical input, the first optical output and the second optical output are separate from each other.

13. The filter of claim 12, wherein the second output optical signal is reflected by the movable reflector to the second optical output.

14. The filter of claim 13, further comprising a first lens positioned between the holographic gratings and the movable reflector to focus the input optical signal and to focus the first and second output optical signals.

15. The filter of claim 14, further comprising a second lens positioned between the movable reflector and the optical input and outputs to focus the input optical signal and to focus the first and second output optical signals.

16. The filter of claim 12, wherein the holographic gratings are arranged in a substantially parallel array.

17. The filter of claim 16, further comprising a planar mirror positioned at a tilted angle with respect to the holographic gratings to reflect the second output optical signals to the movable reflector.

18. The filter of claim 12, wherein the holographic gratings are arranged in a substantially radial pattern.

19. The filter of claim 18, further comprising a curved mirror having a concave surface positioned to reflect the second output optical signal.

20. The filter of claim 19, wherein the first output optical signal is reflected by the curved mirror and the movable reflector to the first optical output.

21. The filter of claim 20, further comprising an additional movable reflector positioned to reflect the second output optical signal from the curved mirror to the second optical output.

22. The filter of claim 12, further comprising a lens positioned between the holographic gratings and the movable reflector to focus the input optical signal, the first output optical signal and the second output optical signal.

23. The filter of claim 22, further comprising a mirror positioned adjacent the holographic gratings to reflect the second output optical signal to the lens.

24. The filter of claim 1, wherein the movable reflector comprises a microelectromechanical system (MEMS) actuated mirror.

25. The filter of claim 24, wherein the MEMS actuated mirror comprises a three-dimensional MEMS actuated mirror.

26. The filter of claim 1, wherein the holographic gratings comprise thin-film holographic gratings.

27. The filter of claim 1, further comprising an input collimator at the optical input.

28. The filter of claim 1, further comprising a first output collimator at the first optical output.

29. The filter of claim 1, further comprising a second output collimator at the second optical output.

30. An optical filter, comprising:
a movable reflector positioned on a first optical path to receive an input light beam carrying an input optical signal that occupies a plurality of wavelength channels and capable of assuming a selected one of a plurality of predetermined positions to reflect the input light beam onto a respective one of a second plurality of optical paths;
a holographic array comprising a plurality of holographic gratings, each of the holographic gratings having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a mirror positioned adjacent the holographic array to reflect the second output light beam onto fourth optical paths;
a first optical port positioned to transmit the input light beam and to receive the second output light beam; and
a second optical port positioned to receive the first output light beam.

31. The filter of claim 30, wherein the second output light beam on the fourth optical path is reflected by the movable reflector onto sixth optical paths to first optical port.

32. The filter of claim 31, further comprising a first lens positioned between the holographic array and the movable reflector to focus the input light beam on any one of the second optical paths and to focus the first and second output light beams on the third and fourth optical paths, respectively.

33. The filter of claim 32, further comprising a second lens positioned between the movable reflector and the first and second optical ports to focus the input light beam on the first optical path and to focus the first and second output light beams on the fifth and sixth optical paths, respectively.

34. The filter of claim 30, wherein the holographic gratings in the holographic array are substantially parallel to each other.

35. The filter of claim 34, wherein the mirror comprises a planar mirror having a surface substantially perpendicular to the holographic gratings.

36. The filter of claim 30, wherein the first optical port comprises a circulator to isolate the second output optical signal from the input optical signal.

37. The filter of claim 30, wherein the movable reflector comprises a microelectromechanical system (MEMS) actuated mirror.

38. The filter of claim 37, wherein the MEMS actuated mirror comprises a three-dimensional MEMS actuated mirror.

39. The filter of claim 30, wherein the holographic gratings comprise thin-film holographic gratings.

40. The filter of claim 30, wherein the first optical port comprises a first collimator.

41. The filter of claim 40, wherein the second optical port comprises a second collimator.

42. An optical filter, comprising:
a movable reflector positioned on a first optical path to receive an input light beam carrying an input optical signal that occupies a plurality of wavelength channels and capable of assuming a selected one of a plurality of predetermined positions to reflect the input light beam onto a respective one of a second plurality of optical paths;
a plurality of holographic gratings arranged in a substantially radial pattern, each of the holographic gratings having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a curved mirror having a concave surface to reflect the second output light beam onto fourth optical path;
a first optical port positioned to transmit the input light beam and to receive the second output light beam; and
a second optical port positioned to receive the first output light beam.

43. The filter of claim 42, wherein the first and second output light beams on the third and fourth optical paths are reflected by the movable reflector onto fifth and sixth optical paths to the second and first optical ports, respectively.

44. The filter of claim 42, wherein the first optical port comprises a circulator to isolate the second output optical signal from the input optical signal.

45. The filter of claim 42, wherein the movable reflector comprises a microelectromechanical system (MEMS) actuated mirror.

46. The filter of claim 45, wherein the MEMS actuated mirror comprises a three-dimensional MEMS actuated mirror.

47. The filter of claim 42, wherein the holographic gratings comprise thin-film holographic gratings.

48. The filter of claim 42, wherein the first optical port comprises a first collimator.

49. The filter of claim 48, wherein the second optical port comprises a second collimator.

50. An optical filter, comprising:
an input optical port capable of transmitting an input light beam carrying an input optical signal that occupies a plurality of wavelength channels on a first optical path;
a movable reflector positioned on the first optical path and capable of assuming a selected one of a plurality of predetermined positions to reflect the input light beam onto a respective one of a second plurality of optical paths;
a holographic array comprising a plurality of holographic gratings substantially in parallel with each other, each of the holographic gratings having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a planar mirror positioned at a tilted angle with respect to the holographic gratings to reflect the second output light beam onto fourth optical path;
a first output optical port positioned to receive the first output light beam; and
a second output optical port positioned to receive the second output light beam.

51. The filter of claim 50, wherein the first and second output light beams on the third and fourth optical paths are reflected by the movable reflector onto fifth and sixth optical paths to the first and second output optical ports, respectively.

52. The filter of claim 51, further comprising a first lens positioned between the holographic array and the movable reflector to focus the input light beam on any one of the second optical paths and to focus the first and second output light beams on the third and fourth optical paths, respectively.

53. The filter of claim 52, further comprising a second lens positioned between the movable reflector and the input and output optical ports to focus the input light beam on the first optical path and to focus the first and second output light beams on the fifth and sixth optical paths, respectively.

54. The filter of claim 50, wherein the movable reflector comprises a microelectromechanical system (MEMS) actuated mirror.

55. The filter of claim 54, wherein the MEMS actuated mirror comprises a three-dimensional MEMS actuated mirror.

56. The filter of claim 50, wherein the holographic gratings comprise thin-film holographic gratings.

57. The filter of claim 50, wherein the input optical port comprises a first collimator.

58. The filter of claim 57, wherein the first output optical port comprises a second collimator.

59. The filter of claim 58, wherein the second output optical port comprises a third collimator.

60. An optical filter, comprising:
an input optical port capable of transmitting an input light beam carrying an input optical signal that occupies a plurality of wavelength channels on a first optical path;
a movable reflector positioned on the first optical path and capable of assuming a selected one of a plurality of predetermined positions to reflect the input light beam onto a respective one of a second plurality of optical paths;
a plurality of holographic gratings arranged in a substantially radial pattern, each of the holographic gratings having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a curved mirror having a concave surface to reflect the second output light beam onto fourth optical path;
a first output optical port positioned to receive the first output light beam; and
a second output optical port positioned to receive the second output light beam.

61. The filter of claim 60, wherein the first output light beam on the third optical path is reflected by the movable reflector onto a fifth optical path to the first output optical port.

62. The filter of claim 61, further comprising a second movable reflector positioned on the fourth optical path to reflect the second output light beam from the curved mirror onto a sixth optical path to the second output optical port.

63. The filter of claim 62, wherein the second movable reflector comprises a microelectromechanical system (MEMS) actuated mirror.

64. The filter of claim 60, wherein the movable reflector comprises a microelectromechanical system (MEMS) actuated mirror.

65. The filter of claim 64, wherein the MEMS actuated mirror comprises a three-dimensional MEMS actuated mirror.

66. The filter of claim 60, wherein the holographic gratings comprise thin-film holographic gratings.

67. The filter of claim 60, wherein the input optical port comprises a first collimator.

68. The filter of claim 67, wherein the first output optical port comprises a second collimator.

69. The filter of claim 68, wherein the second output optical port comprises a third collimator.

70. An optical filter, comprising:
an input optical port capable of transmitting an input light beam carrying an input optical signal that occupies a plurality of wavelength channels on a first optical path;
a movable reflector positioned on the first optical path and capable of assuming a selected one of a plurality of predetermined positions to reflect the input light beam onto a respective one of a second plurality of optical paths;
a plurality of holographic gratings each having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a lens positioned between the holographic gratings and the movable reflector to focus the input light beam on the first optical path and any one of the second optical paths, to focus the first output light beam on the third and fifth optical paths, and to focus the second output light beam on the fourth and sixth optical paths;
a first output optical port positioned to receive the first output light beam on the fifth optical path; and
a second output optical port positioned to receive the second output light beam on the sixth optical path.

71. The filter of claim 70, wherein the holographic gratings are arranged in a substantially parallel array.

72. The filter of claim 71, wherein the mirror comprises a planar mirror having a surface substantially perpendicular to the holographic gratings.

73. The filter of claim 70, wherein the movable reflector comprises a microelectromechanical system (MEMS) actuated mirror.

74. The filter of claim 73, wherein the MEMS actuated mirror comprises a three-dimensional MEMS actuated mirror.

75. The filter of claim 70, wherein the holographic gratings comprise thin-film holographic gratings.

76. The filter of claim 70, wherein the input optical port comprises a first collimator.

77. The filter of claim 76, wherein the first output optical port comprises a second collimator.

78. The filter of claim 77, wherein the second output optical port comprises a third collimator.

79. An optical filter, comprising:
an input optical port capable of transmitting an input light beam carrying an input optical signal that occupies a plurality of wavelength channels on a first optical path;
a movable reflector positioned on the first optical path and capable of assuming a selected one of a plurality of predetermined positions to reflect the input light beam onto a respective one of a second plurality of optical paths;
a second movable reflector positioned on the second optical path and capable of assuming a selected one of a plurality of predetermined positions to reflect the express light beam onto the second output port;
a plurality of holographic gratings each having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a lens positioned between the holographic gratings and each movable reflectors to focus the input light beam on the first optical path and any one of the second optical paths, to focus the first output light beam on the third and fifth optical paths, and to focus the second output light beam on the fourth and sixth optical paths;
a first output optical port positioned to receive the first output light beam on the fifth optical path; and
a second output optical port positioned to receive the second output light beam on the sixth optical path.

80. The filter of claim 79, wherein the holographic gratings are arranged in a substantially parallel array.

81. The filter of claim 79, wherein the movable reflectors comprise a microelectromechanical system (MEMS) actuated mirror.

82. The filter of claim 81, wherein the MEMS actuated mirror comprises a three-dimensional MEMS actuated mirror.

83. The filter of claim 79, wherein the holographic gratings comprise thin-film holographic gratings.

84. The filter of claim 79, wherein the input optical port comprises a first collimator.

85. The filter of claim 84, wherein the first output optical port comprises a second collimator.

86. The filter of claim 85, wherein the second output optical port comprises a third collimator.

87. An optical filter, comprising:
an input optical port capable of transmitting an input light beam carrying an input optical signal that occupies a plurality of wavelength channels on a first optical path;
an array of movable reflectors positioned on each side of the grating array on the first optical path and capable of assuming two selected positions (binary) to reflect the input light beam onto a respective one of a two optical paths;
a plurality of holographic gratings each having a predetermined Bragg wavelength and positioned on a respective one of the second plurality of optical paths to generate a first output light beam carrying a first output optical signal in a selected one of the wavelength channels corresponding to the predetermined Bragg wavelength and a second output light beam carrying a second output optical signal in remaining ones of the wavelength channels excluding the predetermined Bragg wavelength;
a first output optical port which coincides with the input port positioned to receive the first output light beam (drop beam); and
a second output optical port positioned to receive the second output light beam (express beam).

88. The filter of claim 87, wherein the holographic gratings are arranged in a substantially parallel array.

89. The filter of claim 88, wherein the movable reflectors comprise a microelectromechanical system (MEMS) actuated mirror.

90. The filter of claim 87, wherein the holographic gratings comprise thin-film holographic gratings.

91. The filter of claim 87, wherein the input optical port comprises a first collimator.

92. The filter of claim 91, wherein the first output optical port coincides with the input optical port of claim 91.

93. The filter of claim 92, wherein the second output optical port comprises a third collimator.
